(19) United States
(12) Patent Application Publication
(10) Pub. No.: US 2026/0017338 A1
(43) Pub. Date: Jan. 15, 2026

(54) NON-TRANSITORY COMPUTER-READABLE RECORDING MEDIUM, CALCULATION METHOD AND INFORMATION PROCESSING DEVICE

(71) Applicant: Fujitsu Limited, Kawasaki-shi (JP)

(72) Inventors: Norihiko ITANI, Yokohama (JP); Hiroshi IKEDA, Kawasaki (JP); Takashi YAMAZAKI, Kawasaki (JP)

(73) Assignee: Fujitsu Limited, Kawasaki-shi (JP)

(21) Appl. No.: 19/336,727

(22) Filed: Sep. 23, 2025

Related U.S. Application Data
(63) Continuation of application No. PCT/JP2023/012942, filed on Mar. 29, 2023.

(51) Int. Cl. G06F 17/12

(52) U.S. Cl. CPC G06F 17/12

(57) ABSTRACT

A non-transitory computer-readable recording medium that stores a program causing a computer to execute a process is provided. The process includes when repeatedly searching for a solution using evolutionary computation based on an evaluation function that evaluates multiple objective functions, controlling a search direction for the solution according to a distribution of Pareto solutions obtained, and searching for a next generation of solutions.

### CROSS-REFERENCE TO RELATED APPLICATION

This application is a continuation application of PCT/JP2023/012942, filed on Mar. 29, 2023, the entire contents of which are incorporated herein by reference.

### FIELD

A certain aspect of embodiments described herein relates to a non-transitory computer-readable recording medium, a calculation method and an information processing device.

### BACKGROUND ART

Technologies related to multi-objective optimization, which simultaneously optimizes multiple objective functions, have been disclosed (see, for example, Japanese Patent Application Publication No. 2002-203228 and Japanese Patent Application Publication No. 2022-106186).

### SUMMARY

In one aspect, a non-transitory computer-readable recording medium that stores a program causing a computer to execute a process is provided. The process includes: when repeatedly searching for a solution using evolutionary computation based on an evaluation function that evaluates multiple objective functions, controlling a search direction for the solution according to a distribution of Pareto solutions obtained, and searching for a next generation of solutions.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a Pareto solution.

FIG. 2 is a diagram illustrating use of a genetic algorithm in a multi-objective optimization engine.

FIG. 3 is a flowchart of processing step of a genetic algorithm, which is an example of evolutionary computation.

FIG. 4 is a diagram illustrating a case where there are two evaluation functions.

FIG. 5 is a diagram for describing a hypervolume.

FIG. 6 is a diagram illustrating results of a predetermined number of evolutionary computations.

FIG. 7A is a functional block diagram of an overall configuration of an information processing device according to a first embodiment, and FIG. 7B is a hardware configuration diagram of an information processing device.

FIG. 8 is a diagram illustrating a flowchart of an optimization process.

FIG. 9 is a flowchart of details of step S3.

FIG. 10A to FIG. 10C are diagrams illustrating detection of a region with sparse solution distribution when there are two evaluation functions.

FIG. 11A to FIG. 11C are diagrams illustrating detection of a region with sparse solution distribution when there are three evaluation functions.

FIG. 12 is a diagram illustrating a case where a wide gap occurs in distribution of exact solutions.

FIG. 13 is a flowchart for considering a case where a wide gap occurs in distribution of exact solutions that should be obtained in step S3.

FIG. 14 is a flowchart of details of step S34.

FIG. 15A and FIG. 15B are diagrams comparing search processes for Pareto solutions.

FIG. 16A and FIG. 16B are diagrams comparing search processes for Pareto solutions.

FIG. 17A and FIG. 17B are diagrams comparing search processes for Pareto solutions.

FIG. 18A and FIG. 18B are diagrams comparing search processes for Pareto solutions.

FIG. 19 is a diagram of exact solutions for standard problems.

FIG. 20A and FIG. 20B are diagrams comparing search processes for Pareto solutions.

FIG. 21A and FIG. 21B are diagrams comparing search processes for Pareto solutions.

FIG. 22A and FIG. 22B are diagrams comparing search processes for Pareto solutions.

FIG. 23 is a diagram of a relationship between a number of generations and GD.

FIG. 24 is a diagram illustrating a case where multi-objective optimization is performed after single-objective optimization.

### DESCRIPTION OF EMBODIMENTS

In multi-objective optimization, the solution search direction is fixed, so there is a risk that highly uniform Pareto solutions is not obtained.

Optimization problems exist in a variety of industries, including manufacturing and distribution. For example, in the optimization of production plans at manufacturing sites, there is a trade-off between the manufacturing time required for a certain production plan and the costs incurred in proportion to the equipment's operating time. For example, there is a trade-off problem where shortening the manufacturing time increases the operating time of legacy equipment with high operating costs, resulting in increased costs.

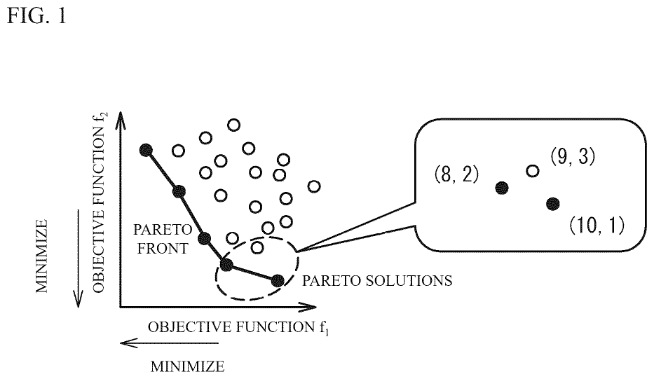

Multi-objective optimization problems that simultaneously optimize multiple objective functions that are in a trade-off relationship generally involve finding a Pareto solution. In the above example, the manufacturing time required for a certain production plan and the costs incurred in proportion to the equipment's operating time are the objective functions. The explanatory variables are the production plan, such as the order in which each product is guided into the production process. A Pareto solution is a solution in which at least one of the multiple objective functions is superior to any other solution. FIG. 1 illustrates an example of a Pareto solution. In FIG. 1, the solution (f1, f2)=(9, 3) is not a Pareto solution because there is no objective function that is superior to (f1, f2)=(8, 2).

In the example in FIG. 1, optimization is performed to minimize each objective function, resulting in a Pareto solution located in the lower left. The line connecting each Pareto solution (the arrangement of each Pareto solution) is called a Pareto front. From the Pareto solutions obtained through multi-objective optimization calculations, users select the optimal solution that suits their purpose. Therefore, to provide the users with more optimal and more options, Pareto solutions must be “breadth,” “convergence to an exact solution,” and “uniformity”. “Uniformity” means that the Pareto solutions are uniform in their breadth and distribution, and that the exact solutions are evenly distributed.

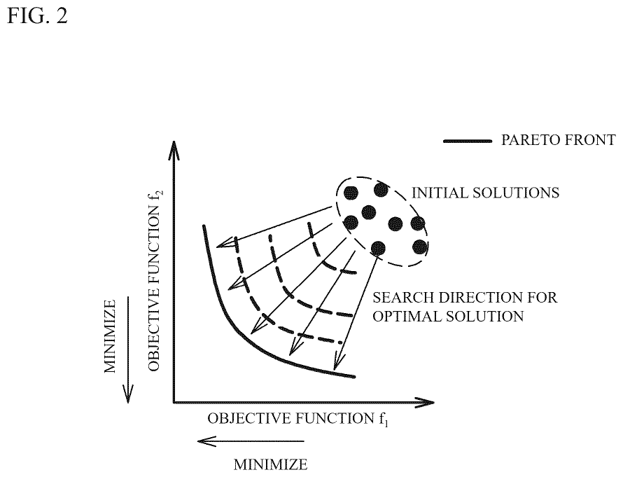

For example, consider a case where multiple objective functions to be optimized are set as the evaluation function of a multi-objective optimization engine and a multi-objective optimization calculation is performed. FIG. 2 illustrates an example of a multi-objective optimization engine using evolutionary computing. Evolutionary computing is a method for searching for solutions over a wide range of initial solutions so that each objective function is minimized. In the example illustrated in FIG. 2, the search direction corresponds to moving left and down from the initial solution.

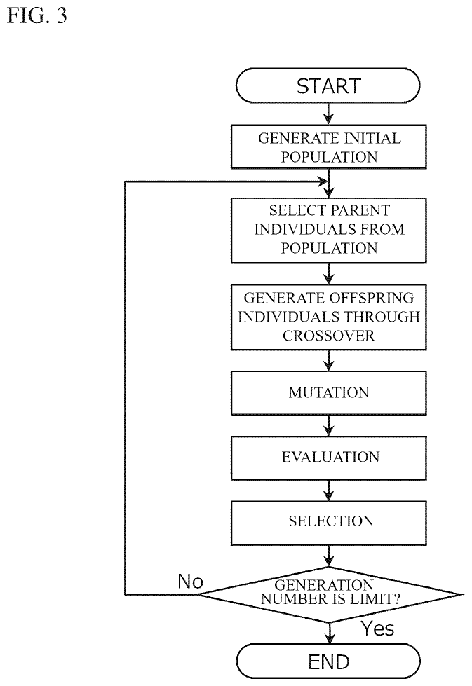

FIG. 3 is a flowchart of the processing steps of a genetic algorithm, an example of evolutionary computing. First, an initial population is generated. Next, parent individuals are selected from the population. Next, offspring individuals are generated from the parent individuals through crossover. Through crossover, offspring individuals inheriting the traits of the parent individual pair selected through selection are generated. Next, traits are randomly changed through mutation. Next, individuals with high fitness (evaluation value) are allowed to survive into the next generation, while individuals with low fitness (evaluation value) are eliminated from the population and selected. In this way, genetic factors are incorporated, and the evaluation function is optimized to improve with each generation.

However, in multi-objective optimization, the solution search direction is fixed, so there is a risk that highly uniform Pareto solutions are obtained. Therefore, the following embodiment describes an information processing device, a calculation method, and a calculation program that can dynamically change the solution search direction.

### First Embodiment

In this embodiment, when the process of evolving solutions using evolutionary computing to improve the evaluation function for evaluating multiple objective functions and searching for solutions is repeated, the solution search direction is controlled according to the distribution of the obtained Pareto solutions to search for the next generation of solutions. The specific solution principle is described below.

The case where there are m objective functions will be described. Each of the m objective functions is an evaluation function. The m evaluation functions are f₁, f₂, . . . , fₘ. f(x) is the evaluation function value for solution x. Therefore, f₁(x₁) is the evaluation function value of evaluation function f1 for solution x₁.

In this embodiment, when controlling the solution search direction, a control point is set based on the density of the distribution of Pareto solutions obtained up to that point, and this control point is reflected in the solution search direction. As an example, a sparse area in the distribution of Pareto solutions obtained up to that point is detected, and a control point is set within that area.

The set control point is set as a new evaluation function fₘ₊₁. Then, the evaluation function f={f₁, f₂, . . . , fₘ, fₘ₊₁} used to search for a solution is optimized. In this embodiment, as an example, the smaller the value of each objective function, the better. Therefore, in this embodiment, a solution is searched for to minimize the evaluation function f={f₁, f₂, . . . , fₘ, fₘ₊₁}. If the coordinates of the control points are (c_{f1}(n), c_{f2}(n), . . . , c_{fm}(n)), fₘ₊₁ can be expressed, for example, as the following Formula. In the following formula, fₘ₊₁ is the distance between each coordinate of the Pareto solutions obtained up to that point and the control point. “n” represents the number of times evolutionary computation has been performed (the current number of generations).

$${f}_{m + 1} = \sqrt{{( {c}_{f 1} ( n ) - {f}_{1} ( {x}_{1} ) )}^{2} + {( {c}_{f 2} ( n ) - {f}_{2} ( {x}_{1} ) )}^{2} … + {( {c}_{fm} ( m ) - {f}_{m} ( {x}_{1} ) )}^{2}} \qquad [ Formula 1 ]$$

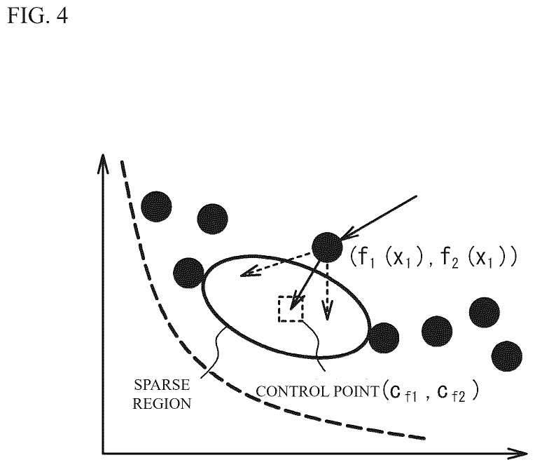

FIG. 4 illustrates a case where there are two evaluation functions. For a given solution x₁, coordinates (f₁(x₁), f₂(x₁)) are set to control points (c_{f1}, c_{f2}) in the coarse region, and fₘ₊₁ is reflected in the evaluation function used to search for a solution, thereby controlling the solution search direction. Controlling the solution search direction in this way allows the solution search direction to be dynamically changed. As a result, Pareto solutions with high uniformity can be obtained.

For example, the control points can be determined using the following procedure. First, Pareto solutions are extracted from the solutions obtained during the evolutionary computation. Next, the coordinates of the centers of gravity of m (the number of evaluation functions) random combinations of Pareto solutions are calculated. Next, each center of gravity is added to the Pareto solutions to determine the hypervolume (HV), and the center of gravity with the largest HV is detected as the control point. This is because the coordinates of the region with the coarsest solutions will result in the largest increase in HV when added to the Pareto solutions.

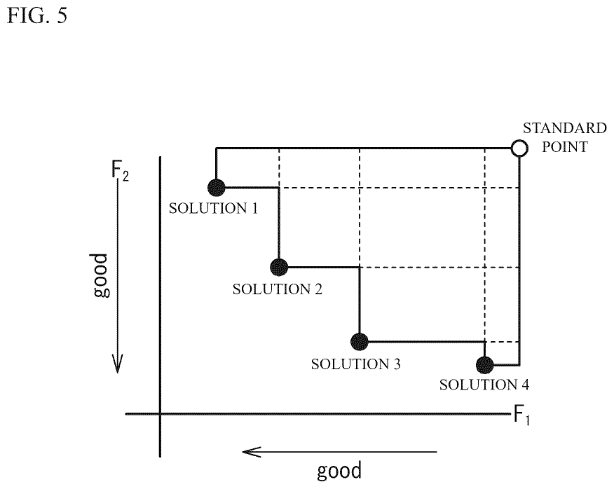

Here, HV will be descried. FIG. 5 is a diagram explaining HV. HV is a performance index of Pareto solutions. Specifically, HV represents the area or volume of the region in the objective function space formed by a certain reference point and the solution set obtained by the algorithm. As an example, the reference point can be set to (0,0) and the standardized values of each objective function can be used. When there are two objective functions, the area illustrated in FIG. 5 is the HV. The larger this HV, the wider the range of solutions, and therefore, it can be determined that a good result has been obtained.

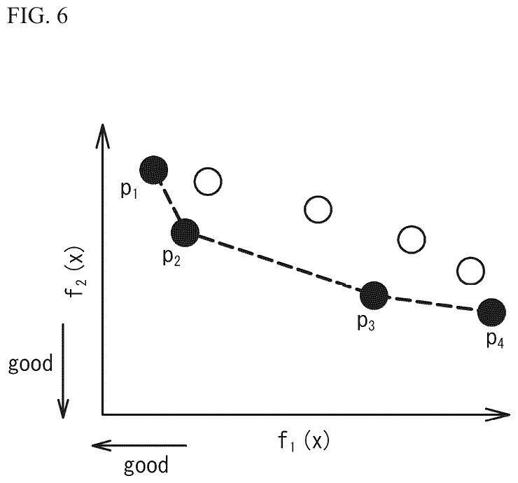

FIG. 6 is a diagram illustrating the results of a predetermined number of iterations of evolutionary computing. Assume that four Pareto solutions have been obtained by a predetermined number of iterations of evolutionary computing. The coordinates of each Pareto solution are p₁, p₂, p₃, and p₄. Calculate the center of gravity c_{2, 4} between p₂ and p₄, calculate the center of gravity c_{1, 2} between p₁ and p₂. The following centers of gravity are calculated in the same manner. Next, the HV is calculated from (p₁, p₂, . . . , p₄, c_{2, 4}), another HV is calculated from (p₁, p₂, . . . , p₄, c_{1, 2}). The following HVs are calculated in the same manner. The center of gravity c where the HV is maximum is then detected as the control point.

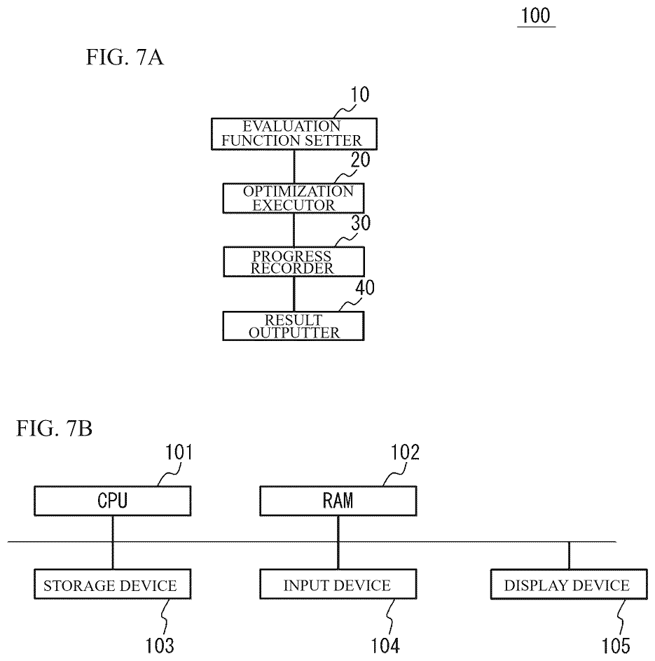

Next, the device configuration for realizing the above solution principle will be described. FIG. 7A is a functional block diagram of the overall configuration of an information processing device 100 according to the first embodiment. The information processing device 100 is, for example, a server for optimization processing. As illustrated in FIG. 7A, the information processing device 100 functions as an evaluation function setter 10, an optimization executor 20, a progress recorder 30, a result outputter 40, and so on.

FIG. 7B is a block diagram illustrating the hardware configuration of the information processing device 100. As illustrated in FIG. 7B, the information processing device 100 includes a CPU 101, a RAM 102, a storage device 103, an input device 104, a display device 105 and the like.

The CPU (Central Processing Unit) 101 is a central processing unit. The CPU 101 includes one or mode cores. The RAM (Random Access Memory) 102 is a volatile memory that temporarily stores programs executed by the CPU 101 and data processed by the CPU 101. The storage device 103 is a non-volatile storage device. For example, the storage device 103 may be a ROM (Read Only Memory), a solid state drive (SSD) such as a flash memory, or a hard disk driven by a hard disk drive. The storage device 103 stores a calculation program. The input device 104 is a device for the user to input necessary information, and is a keyboard, a mouse, or the like. The display device 105 is a display device for displaying results output by the result outputter 40 on a screen. The CPU 101 executes the calculation program, thereby realizing the functions of each unit of the information processing device 100. Note that the functions of each unit of the information processing device 100 may be configured using dedicated circuits or the like.

The evaluation function setter 10 sets multiple evaluation functions. The evaluation function setter 10 may set two evaluation functions, or three or more evaluation functions. In this embodiment, the evaluation function setter 10 sets evaluation functions f₁ to fₘ for m objective functions. The optimization executor 20 performs optimization so that the evaluation function f used to search for a solution is optimized. The progress recorder 30 records the results of the optimization performed by the optimization executor 20. The result outputter 40 outputs the results of the optimization performed by the optimization executor 20.

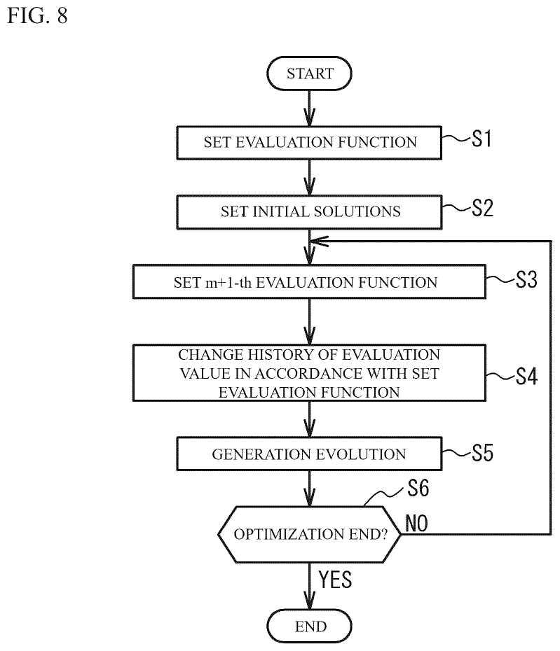

The optimization process will be described below with reference to the flowchart in FIG. 8. First, the evaluation function setter 10 sets m evaluation functions (fₙ; n=1 to m) from the m objective functions (Step S1). Each evaluation function represents, for example, the production completion time in the production process and the production cost. The shorter the production completion time, the better, and the lower the cost, the better.

Next, the optimization executor 20 sets the initial solution to a random value (Step S2). There are multiple initial solutions. The user may input the initial solution using the input device 104.

Next, the optimization executor 20 sets the (m+1)-th evaluation function fₘ₊₁ (Step S3). Details of Step S3 will be described later.

Next, the optimization executor 20 changes the history of evaluation values recorded by the progress recorder 30 to match the set evaluation function (Step S4). Step S4 is executed for the following reason. The evaluation function f changes every time a control point is changed. Therefore, since the evaluation values prior to the (n−1)-th evolution, which are referenced when calculating the solution for the n-th evolution, are calculated using a different evaluation function from the n-th evolution, it is preferable to align the evaluation criteria. Therefore, by executing Step S4, the evaluation function f of the solutions of generations (n−1) and below is matched to the evaluation function f used in the n-th generation of evolutionary calculation.

Next, the optimization executor 20 performs generational evolution on the solutions obtained so far (step S5). During the first execution of step S5, the initial solution is subjected to generational evolution. During the second and subsequent executions of step S5, the group of solutions that have not yet been selected are the evolution targets.

Next, the optimization executor 20 determines whether the optimization has ended (step S6). For example, it determines whether the number of generational evolutions has reached a predetermined number. If the determination in step S6 is “No,” execution begins again from step S3. If the determination in step S6 is “Yes,” execution of the flowchart ends.

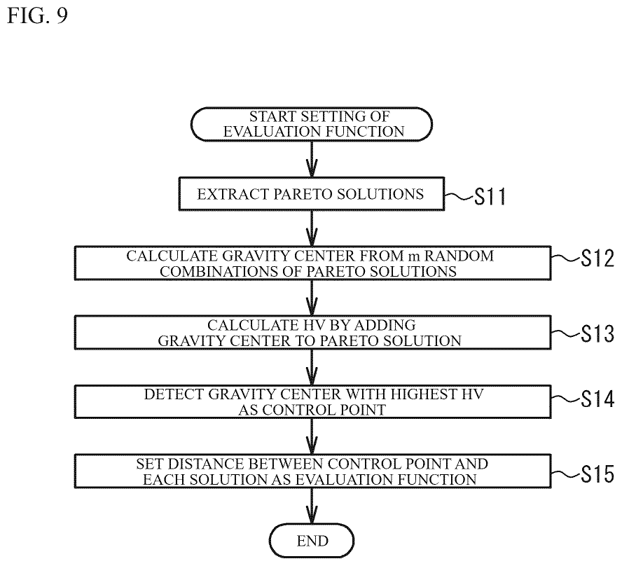

FIG. 9 is a flowchart of the details of step S3. As illustrated in FIG. 9, the optimization executor 20 extracts Pareto solutions (step S11). During the first execution of step S11, Pareto solutions are extracted from the initial solutions. When step S11 is executed for the second time or later, Pareto solutions are extracted from the solutions obtained up to that point.

Next, the optimization executor 20 calculates the center of gravity for m random combinations of the coordinates of the Pareto solutions extracted in step S11 (step S12).

Next, the optimization executor 20 adds the center of gravity to each coordinate of the Pareto solutions to calculate HV (step S13).

Next, the optimization executor 20 detects the center of gravity where HV is maximized as the control point (step S14).

Next, the optimization executor 20 reflects the distance fₘ₊₁ between the control point and each coordinate of the Pareto solution in the evaluation function f (step S15). Through the above process, the (m+1)-th evaluation function can be set.

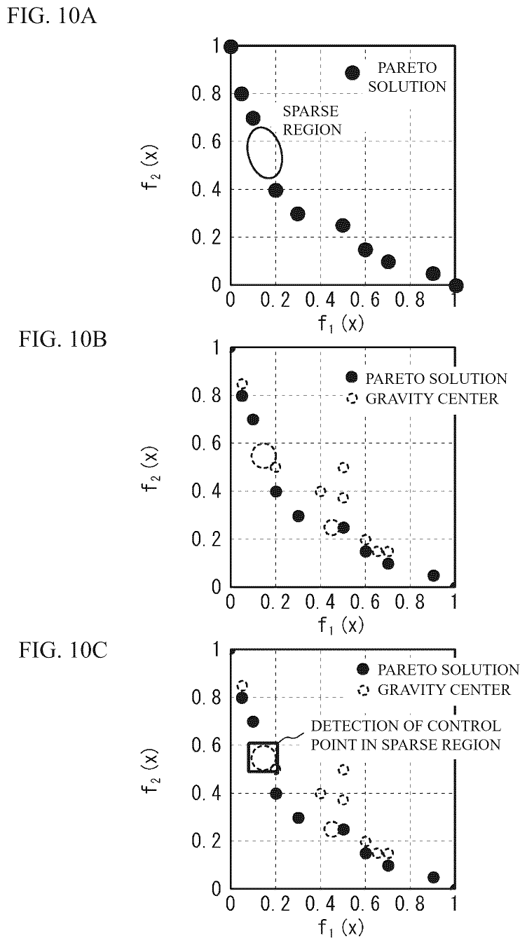

FIG. 10A to FIG. 10 Care diagrams illustrating the detection of regions where the solution distribution is sparse when there are two evaluation functions. As illustrated in FIG. 10A, assume that 10 Pareto solutions have been obtained. In this case, sparse regions have occurred. Next, as illustrated in FIG. 10B, the center of gravity coordinates for random combinations (10 pairs) of the coordinates of the Pareto solutions are calculated. Next, as illustrated in FIG. 10C, the center of gravity coordinates where HV is maximized can be detected as the control point.

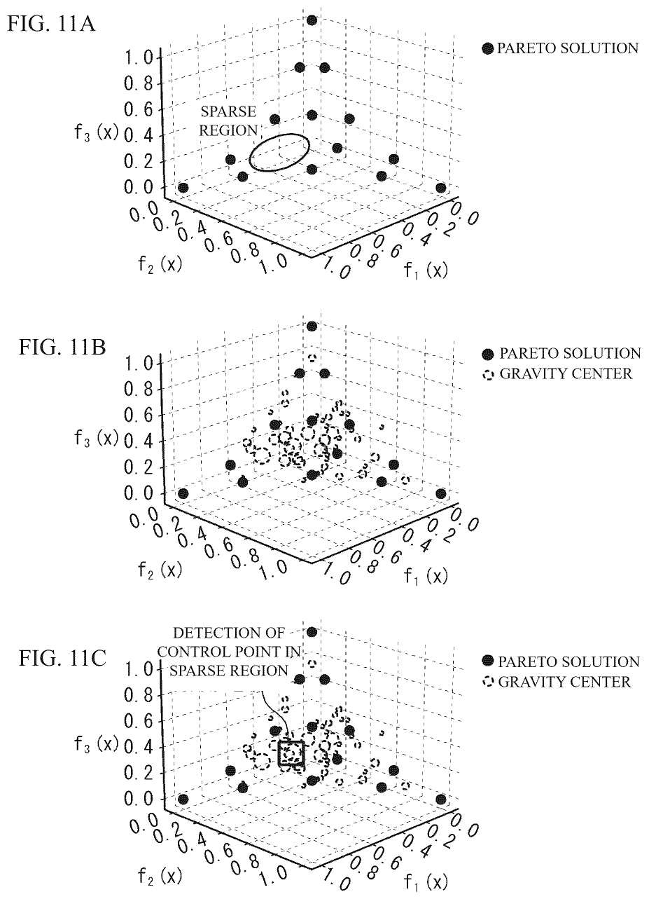

FIG. 11A to FIG. 11C illustrate the detection of regions where the solution distribution is sparse when there are three evaluation functions. As illustrated in FIG. 11A, 14 Pareto solutions have been obtained. In this case, sparse regions have been identified. Next, as illustrated in FIG. 11B, the coordinates of centers of gravity of random combinations (50 pairs) of the coordinates of the Pareto solutions are calculated. Next, as illustrated in FIG. 11C, the coordinates of centers of gravity with the highest HV can be detected as the control point.

According to this embodiment, when the process of searching for solutions by evolving them using evolutionary computing to improve the evaluation function f, which evaluates multiple objective functions, is repeated, the search direction for solutions is controlled according to the distribution of the obtained Pareto solutions, and the next generation of solutions is searched for. This allows the search direction for solutions to be dynamically changed, resulting in highly uniform Pareto solutions.

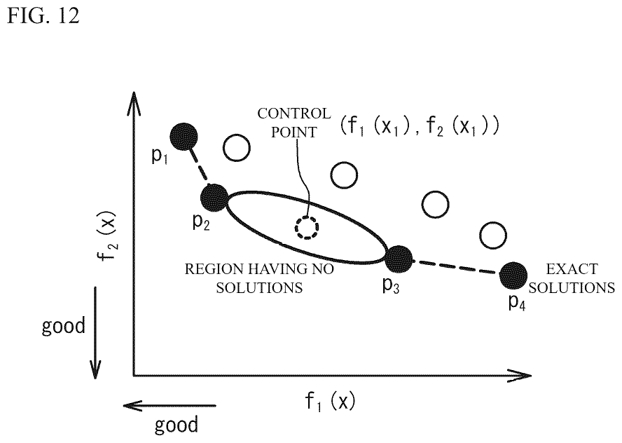

As illustrated in FIG. 12, there may be wide gaps in the distribution of exact solutions that should be obtained. In this case, even if the search direction for a solution points toward the wide gap, unnecessary calculations will occur. Therefore, it is preferable to eliminate unnecessary calculations by excluding the wide gaps from the search range. For example, if a control point is detected within the same region a certain number of times in succession, it is preferable to determine that no solution exists in that region and to perform processing that prevents the region from being adopted as a control point thereafter.

For example, the centers of gravity are sorted in descending order of HV and set as control point candidates (1). Next, the center of gravity with the highest HV is selected as a control point candidate and checked to ensure that it does not exist in the control point NG list and that no control points in the same region (for example, a region within ±3% of the control point candidate) have appeared more than a certain number of times (hereinafter referred to as the control point condition) (2). If condition (2) is met, the control point is adopted, the control point is stored, and the process ends (3). Next, if the same control point appears a certain number of times in a row and does not satisfy the conditions, the coordinates are registered in the NG list (4). Coordinates registered in the NG list are not used as control points. Next, the center of gravity with the next largest HV is selected as the control point candidate and the adoption conditions are determined (5). The determination result is then obtained and the process returns to (3).

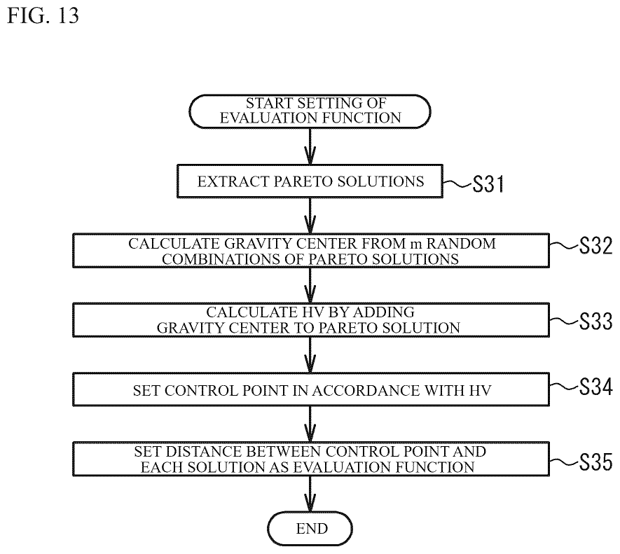

FIG. 13 is a flowchart for step S3, which considers the case where a wide gap exists in the distribution of exact solutions that should have been obtained. As illustrated in FIG. 13, the optimization executor 20 extracts Pareto solutions (step S31). When step S31 is executed the first time, Pareto solutions are extracted from the initial solutions. When step S31 is executed the second time or later, Pareto solutions are extracted from the solutions obtained up to that point.

Next, the optimization executor 20 calculates the center of gravity using m random combinations of the coordinates of the Pareto solutions extracted in step S31 (step S32).

Next, the optimization executor 20 adds the center of gravity to each coordinate of the Pareto solution to calculate HV (step S33).

Next, the optimization executor 20 sets control points based on the HVs (Step S34).

Next, the optimization executor 20 reflects the distances between the control points and each coordinate of the Pareto solutions in the evaluation function f (Step S35). Through the above processing, the (m+1)-th evaluation function fₘ₊₁ can be reflected in the evaluation function f.

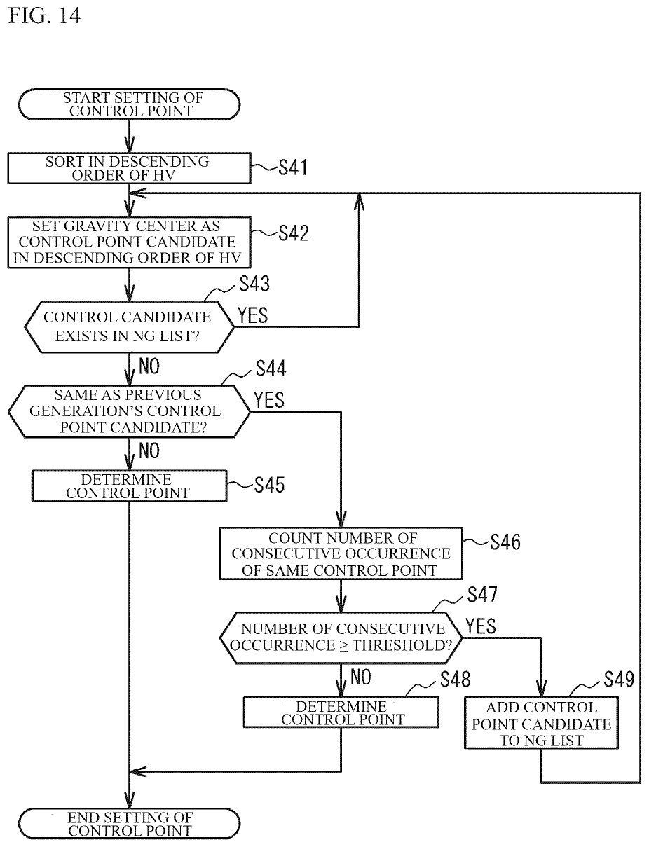

FIG. 14 is a flowchart of the details of Step S34. As illustrated in FIG. 14, the optimization executor 20 sorts the results in descending order of HV (Step S41).

Next, the optimization executor 20 sets the centers of gravity as control point candidates in descending order of HV (Step S42).

Next, the optimization executor 20 determines whether the control point candidates are on the NG list (Step S43). If the determination in Step S43 is “Yes,” processing resumes from Step S42. Therefore, the coordinates registered in the NG list will not be set as control points.

If step S43 returns “No,” the optimization executor 20 determines whether the control point candidate is the same as the previous generation's control point candidate (step S44).

If step S44 returns “No,” the optimization executor 20 determines the control point candidate as the control point (step S45). Execution of the flowchart then ends.

If step S44 returns “Yes,” the optimization executor 20 counts the number of consecutive occurrences of the same control point (step S46).

Next, the optimization executor 20 determines whether the number of consecutive occurrences counted in step S46 is equal to or greater than a threshold (step S47).

If step S47 returns “No,” the optimization executor 20 determines the control point candidate as the control point (step S48). Execution of the flowchart then ends.

If step S47 returns “Yes,” the optimization executor 20 adds the control point candidate to the NG list (step S49). Then, execution resumes from step S42.

Here, a simulation was performed to search for a solution to a standard problem using the method of this embodiment. Let F(x)=(f₁(x₁), f₂(x)). Let f₁(x₁) =x₁. f₂(x) can be expressed as the following formulas. Note that m=30 and xᵢ ∈[0, 1].

$${f}_{2} ( x ) = g ( {x}_{2} , … , {x}_{m} ) [ 1 - \sqrt{{x}_{1} / g ( {x}_{2} , … , {x}_{m} )} ] \qquad [ Formula 2 ]$$

$$g ( {x}_{2} , … , {x}_{m} ) = 1 + 9 ( {\sum }_{i = 2}^{m} {x}_{i} ) / ( m - 1 ) \qquad [ Formula 3 ]$$

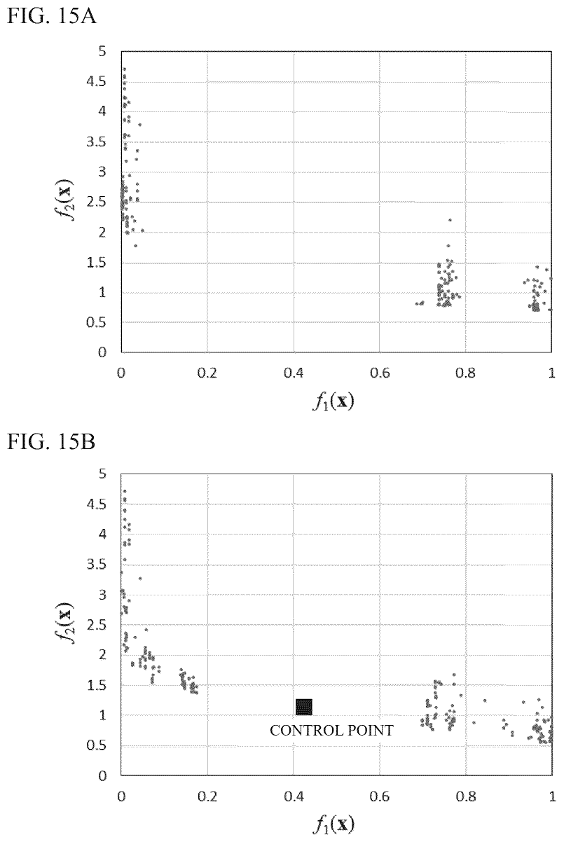

FIG. 15A and FIG. 15B illustrate a comparison of the search process for Pareto solutions. In both FIG. 15A and FIG. 15B, the number of generations was 240. FIG. 15A illustrates the results of a solution search without setting control points. FIG. 15B illustrates the results of a solution search with control points set. Compared to FIG. 15A, FIG. 15B illustrates that the distribution of solutions has been smoothed out and is more uniform.

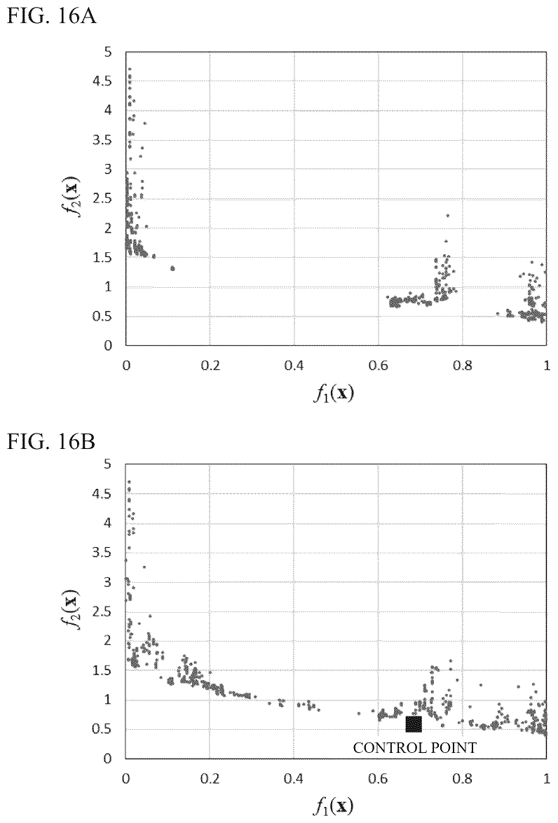

FIG. 16A and FIG. 16B illustrate a comparison of the search process for Pareto solutions. The number of generations was set to 720. FIG. 16A illustrates the results of a solution search without setting control points. FIG. 16B illustrates the results of a solution search with control points set. Compared to FIG. 16A, FIG. 16B illustrates that the distribution of solutions has been smoothed out and is more uniform.

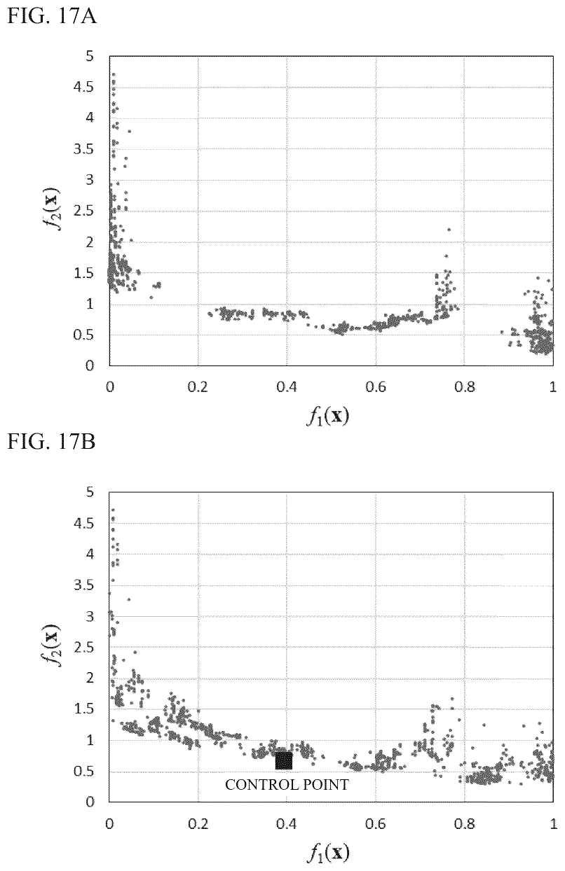

FIG. 17A and FIG. 17B illustrate a comparison of the search process for Pareto solutions. The number of generations was set to 1440. FIG. 17A illustrates the results of a solution search without setting control points. FIG. 17B illustrates the results of a solution search with control points set. Compared to FIG. 17A, the deviation in the distribution of solutions is eliminated in FIG. 17B, resulting in higher uniformity.

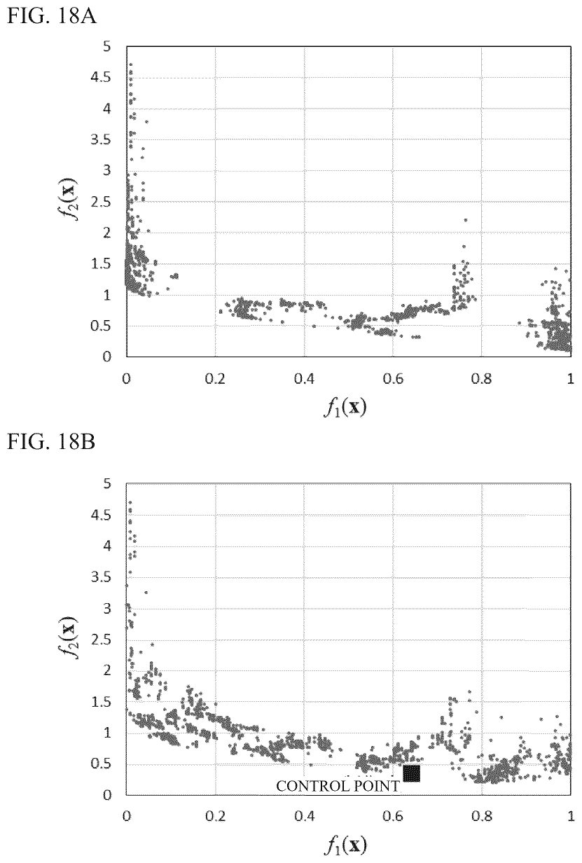

FIG. 18A and FIG. 18B illustrate a comparison of the search process for Pareto solutions. The number of generations was 2040. FIG. 18A illustrates the results of searching for solutions without setting control points. FIG. 18B illustrates the results of searching for solutions with control points set. Compared to FIG. 18A, FIG. 18B illustrates that the distribution of solutions has been eliminated and is more uniform.

For example, CR (Cover Rate) can be used as an evaluation index for the uniformity of Pareto solutions. CR represents the proportion of solutions found within the divided regions obtained by dividing the area between the maximum and minimum values of the Pareto solutions for each objective function. The higher the CR, the more uniform the Pareto solutions obtained. The CR in FIG. 18B was 25% higher than the CR in FIG. 18A.

Next, we performed a simulation to search for a solution to a standard problem when there are large gaps in the distribution of exact solutions. Let F(x)=(f₁(x₁), f₂(x)). Let f₁(x₁)=x₁. f₂(x) can be expressed as follows. Note that N=3 and xᵢ ∈[−5, 5].

$${f}_{1} ( x ) = {\sum }_{n = 1}^{N - 1} ( - 10 exp ( - 0.2 \sqrt{{x}_{n}^{2} + {x}_{n + 1}^{2}} ) ) \qquad [ Formula 4 ]$$

$${f}_{2} ( x ) = {\sum }_{n = 1}^{N} ( {\vert {x}_{n} \vert}^{08} + 5 {sin ( {x}_{n} )}^{3} ) \qquad [ Formula 5 ]$$

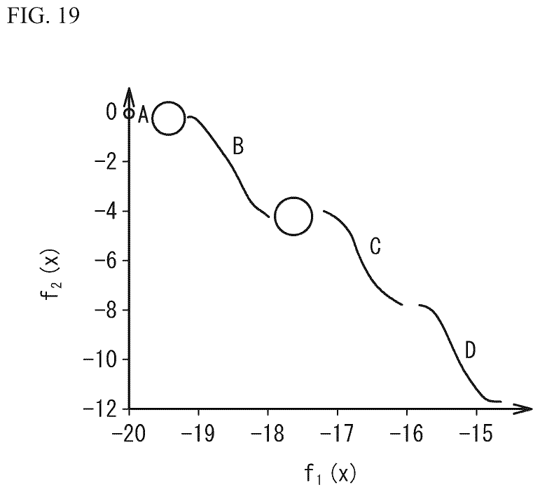

FIG. 19 illustrates the exact solution to this standard problem. As illustrated in FIG. 19, there are large gaps in the distribution of exact solutions.

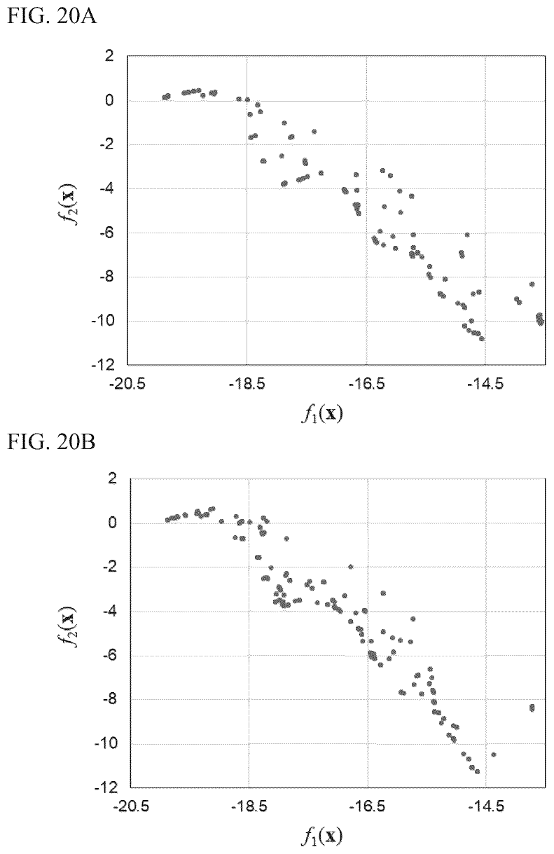

FIG. 20A and FIG. 20B illustrate a comparison of the search process for Pareto solutions. In both FIG. 20A and FIG. 20B, the number of generations was 760. FIG. 20A illustrates the results of a solution search without setting control points. FIG. 20B illustrates the results of setting control points and searching for a solution. Compared to FIG. 20A, FIG. 20B illustrates that the distribution of solutions has been improved and is more uniform.

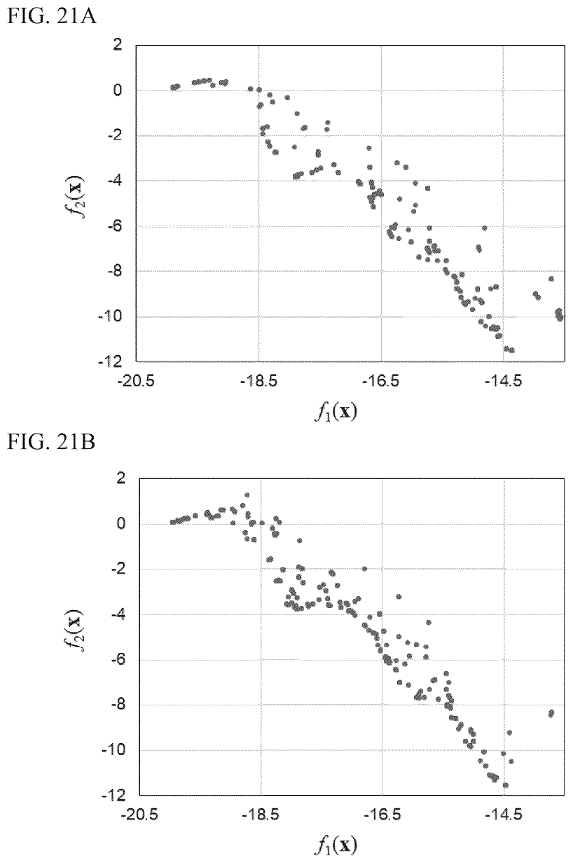

FIG. 21A and FIG. 21B illustrate a comparison of the search process for Pareto solutions. The number of generations was set to 1000. FIG. 21A illustrates the result of searching for solutions without setting control points. FIG. 21B illustrates the result of searching for solutions with control points set. Compared to FIG. 21A, the bias in the solution distribution in FIG. 21B has been eliminated, resulting in higher uniformity.

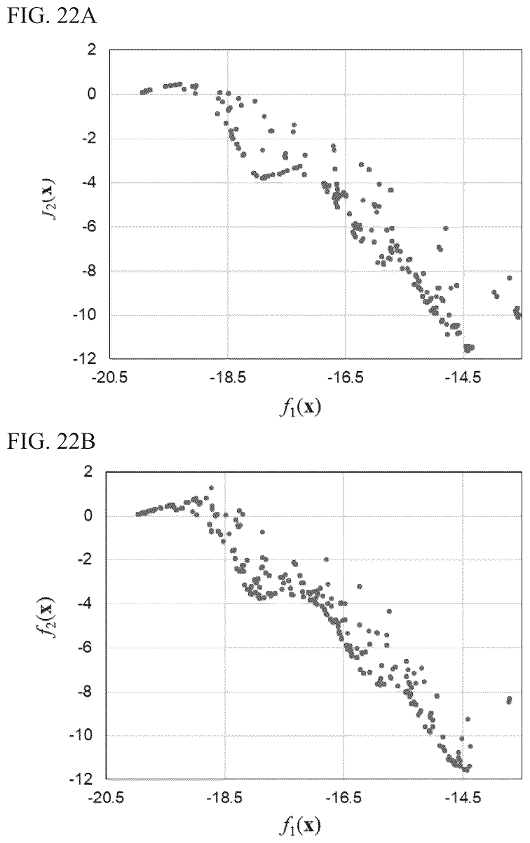

FIG. 22A and FIG. 22B illustrate a comparison of the search process for Pareto solutions. The number of generations was set to 1370. FIG. 22A illustrates the result of searching for solutions without setting control points. FIG. 22B illustrates the result of searching for solutions with control points set. Compared to FIG. 22A, the bias in the solution distribution in FIG. 22B has been eliminated, resulting in higher uniformity.

The CR in FIG. 22B was 18% higher than the CR in FIG. 22A.

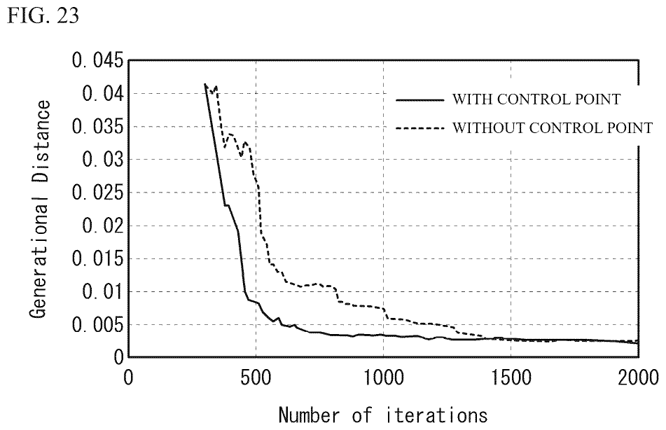

FIG. 23 illustrates the relationship between the number of generations and GD (Generational Distance). GD represents the average distance between each Pareto solution and the exact solution. The smaller the GD, the higher the convergence to the exact solution. As illustrated in FIG. 23, when a control point was set, the GD was reduced by more than 99% from the initial value by the 1,370th generation evolution, indicating that all convergence occurred by the 1,370th generation evolution.

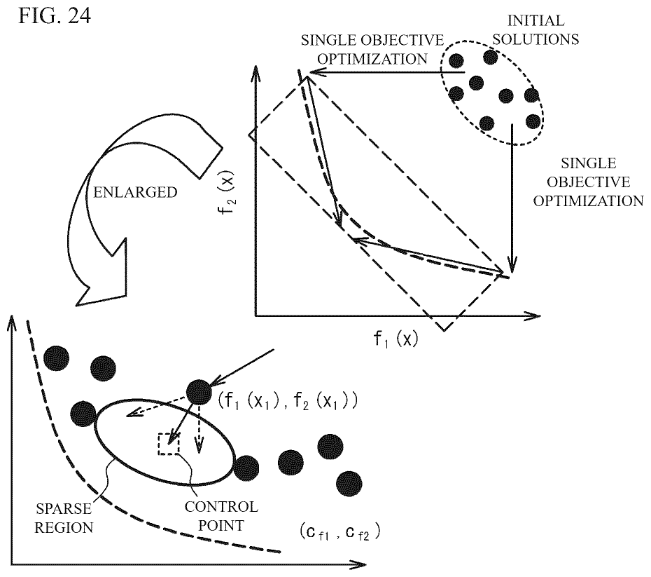

Note that in the above example, multi-objective optimization was performed from an initial solution group, but this is not limited to this. For example, single-objective optimization may be performed for an initial solution using each of a plurality of objective functions as an evaluation function to calculate a single-objective optimal solution that is better than the initial solution, and multi-objective optimization may be performed using the calculated single-objective optimal solution (Pareto solution) as a starting point. For example, as illustrated in FIG. 24, multi-objective optimization may be performed to set the control points using the Pareto solutions obtained by single-objective optimization of m objective functions fᵢ(x) (i=1, . . . , m) as a starting point. In this case, the Pareto solutions are approached by single-objective optimization with a small amount of calculation, and then multi-objective optimization is performed, thereby reducing the amount of calculation required to reach the Pareto solutions.

Note that while a genetic algorithm was used for evolutionary computation in the above examples, other types of evolutionary computation may also be used.

In each of the above examples, the optimization executor 20 is an example of an executor that, when repeating the process of searching for a solution using evolutionary computation based on an evaluation function that evaluates multiple objective functions, controls the solution search direction in accordance with the distribution of the obtained Pareto solutions and executes the process of searching for a next-generation solution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the above-described coolant may be cold water or an antifreeze solution.

What is claimed is:

1. A non-transitory computer-readable recording medium that stores a program causing a computer to execute a process, the process including:
when repeatedly searching for a solution using evolutionary computation based on an evaluation function that evaluates multiple objective functions, controlling a search direction for the solution according to a distribution of Pareto solutions obtained, and searching for a next generation of solutions.

2. The medium as claimed in claim 1,
wherein the process includes, when controlling the search direction for the solution, setting a control point according to a density of the distribution of the Pareto solutions, and reflecting the control point in the search direction for the solution.

3. The medium as claimed in claim 2,
wherein the process includes detecting a sparse region in the distribution of the Pareto solutions, and setting the control point within the sparse region.

4. The medium as claimed in claim 3,
wherein the process includes calculating coordinates of centers of gravity of combinations of coordinates of the Pareto solutions, adding each of the centers of gravity to each of the Pareto solutions to obtain a hypervolume, and detecting a center of gravity at which the hypervolume is maximized as the control point.

5. The medium as claimed in claim 2,
wherein the direction of search for the solution is controlled by reflecting each distance between the control point and each of the coordinates of the Pareto solutions in the evaluation function.

6. The medium as claimed in claim 2,
wherein the process includes, when the control point is set multiple times, determining whether the control point falls within a specified range a specified number of times in succession, and eliminating the control point from the specified range if it is determined that the control point falls within the specified range.

7. The medium as claimed in claim 1,
wherein the evaluation function for solutions of a (n−1)-th generation or later is adjusted to the evaluation function for an n-th generation of evolutionary calculation.

8. The medium as claimed in claim 1,
wherein the process includes, for initial solutions, performing single-objective optimization by using each of the multiple objective functions as an evaluation function to calculate a single-objective optimal solution that has a better value than the initial solutions, and evolving calculated single-objective optimal solution by using the evolutionary computation.

9. A calculation method comprising:
when repeatedly searching for a solution using evolutionary computation based on an evaluation function that evaluates multiple objective functions, controlling a search direction for the solution according to a distribution of Pareto solutions obtained, and searching for a next generation of solutions.

10. The calculation method as claimed in claim 9 further comprising:
when controlling the search direction for the solution, setting a control point according to a density of the distribution of the Pareto solutions, and reflecting the control point in the search direction for the solution.

11. The calculation method as claimed in claim 10 further comprising:
detecting a sparse region in the distribution of the Pareto solutions, and setting the control point within the sparse region.

12. The calculation method as claimed in claim 11 further comprising:
calculating coordinates of centers of gravity of combinations of coordinates of the Pareto solutions, adding each of the centers of gravity to each of the Pareto solutions to obtain a hypervolume, and detecting a center of gravity at which the hypervolume is maximized as the control point.

13. The calculation method as claimed in claim 10,
wherein the direction of search for the solution is controlled by reflecting each distance between the control point and each of the coordinates of the Pareto solutions in the evaluation function.

14. The calculation method as claimed in claim 10 further comprising:
when the control point is set multiple times, determining whether the control point falls within a specified range a specified number of times in succession, and eliminating the control point from the specified range if it is determined that the control point falls within the specified range.

15. The calculation method as claimed in claim 9,
wherein the evaluation function for solutions of a (n−1)-th generation or later is adjusted to the evaluation function for an n-th generation of evolutionary calculation.

16. The calculation method as claimed in claim 9 further comprising:
for initial solutions, performing single-objective optimization by using each of the multiple objective functions as an evaluation function to calculate a single-objective optimal solution that has a better value than the initial solutions, and evolving calculated single-objective optimal solution by using the evolutionary computation.

17. An information processing device comprising:
a memory; and
a processor coupled to the memory and configured to:
when repeatedly searching for a solution using evolutionary computation based on an evaluation function that evaluates multiple objective functions, control a search direction for the solution according to a distribution of Pareto solutions obtained, and searching for a next generation of solutions.

18. The information processing device as claimed in claim 17
wherein the process includes, when controlling the search direction for the solution, setting a control point according to a density of the distribution of the Pareto solutions, and reflecting the control point in the search direction for the solution.

19. The information processing device as claimed in claim 18,
wherein the process includes detecting a sparse region in the distribution of the Pareto solutions, and setting the control point within the sparse region.

20. The information processing device as claimed in claim 19,
wherein the process includes calculating coordinates of centers of gravity of combinations of coordinates of the Pareto solutions, adding each of the centers of gravity to each of the Pareto solutions to obtain a hypervolume, and detecting a center of gravity at which the hypervolume is maximized as the control point.
